(19) United States
(12) Patent Application Publication
(10) Pub. No.: US 2026/0021955 A1
(43) Pub. Date: Jan. 22, 2026

(54) DISPOSABLE SINGLE SERVE LIQUOR COFFEE BEVERAGE POD WITH ONE COMPARTMENT FOR CONTAINING COFFEE AND A SEPARATE COMPARTMENT FOR CONTAINING LIQUOR

(71) Applicants: Nickolas CHRISTENSEN, San Jose, CA (US); James HAO, San Jose (CA)

(72) Inventors: Nickolas CHRISTENSEN, San Jose, CA (US); James HAO, San Jose (CA)

(21) Appl. No.: 18/780,316

(22) Filed: Jul. 22, 2024

(51) Int. Cl. B65D 85/804; B65D 51/00

(52) U.S. Cl. CPC B65D 85/8067; B65D 51/002; B65D 85/8052; B65D 85/8061

(57) ABSTRACT

The present invention pertains to a beverage pod that has multiple separate compartments for use in an automatic beverage brewing machine. The beverage pod has at least two separate compartments inside. One compartment can hold one beverage ingredient, whereas another compartment can hold a different beverage ingredient. These ingredients can be either a solid or a liquid and are kept separated until the brewing process. During the brewing process, these ingredients can be combined with hot or cold water to produce a uniquely flavored beverage for human consumption.

### BACKGROUND OF THE INVENTION

### Field of the Invention

Embodiments of the present invention generally relate to a disposable single serve beverage pod with multiple separate compartments for containing multiple beverage ingredients.

### Background of the Present Invention

Coffee is one of the most popular beverages globally, and the market is expanding well into the future. Coffee is delicious, both in taste and smell. It comes in numerous varieties, such as espresso, cappuccino, latte, thereby allowing individuals to tailor their coffee experiences to their preferences. In addition, there are numerous coffee bean varieties, roasting techniques, and brewing methods, offering a wide range of flavors and aromas to explore. Coffee also contains caffeine, a stimulant that can increase alertness and reduce fatigue, making it a go-to choice for professionals, students, and others to kickstart their day or boost their energy levels. There may even be health benefits to drinking coffee.

In order to make coffee more convenient and available, there has been a proliferation of simple, inexpensive coffee brewing machines that use disposable, single-serve coffee pods. A single serve coffee pod, commonly known as a coffee pod, capsule, or cartridge, is a pre-packaged portion of ground coffee beans enclosed in a filter housed within a plastic cup with a sealed, aluminum lid. In other embodiments, the lid can be formed from plastic or some other material. These pods are designed for single use and are compatible with specific coffee brewing systems, such as pod coffee and espresso makers Keurig™ and Nespresso™. Users simply insert a self-contained coffee pod into the coffee machine filled with water, press a button, and coffee is automatically dispensed into an awaiting cup. Thereby, consumers can enjoy a fresh, hot cup of coffee anytime at home, work, or travel.

One problem with these traditional coffee pods is that they are uniformly made the same way. Because of their simplistic design, they are quite inexpensive to manufacture. However, the pods' simple construction severely restricts and limits the way by which the pods can be filled and used. Consequently, beverage choices are severely limited.

### SUMMARY OF THE INVENTION

Embodiments of the present invention pertain to a beverage pod for use in a beverage brewing machine. The beverage pod has at least two compartments. One compartment holds a dry ingredient, such as ground coffee. A separate compartment residing inside the beverage pod is a container for holding a liquid. The dry and wet contents from these separate compartments are stored and kept apart in the beverage pod. The dry contents are kept dry in the dry compartment, while the liquid contents are kept in the liquid container. When inserted into the beverage brewing machine, the dry ingredient is brewed by hot water and the brewed beverage flows out from the beverage pod. The liquid inside the internal liquid container is released and flows out from the beverage pod.

### BRIEF DESCRIPTION OF DRAWINGS

The accompanying drawings, which are incorporated in and form a part of this specification and in which like numerals depict like elements, illustrate embodiments of the present disclosure and, together with the detailed description, serve to explain the principles of the disclosure.

FIG. 1 shows a beverage pod that has an internal liquid container.

FIG. 2 shows an embodiment of a bottom loading liquid containing container that fits inside a beverage pod.

FIG. 3 shows an embodiment of a top loading liquid containing container that fits inside a beverage pod.

FIG. 4 shows various embodiments of the invention having one, two, or

three pieces with corresponding top and bottom loading options.

FIG. 5 shows various embodiments for fabricating the beverage pod with the use of glue.

FIG. 6 shows various embodiments of a multi-compartment snap-on beverage pod configuration.

FIG. 7 shows various embodiments of a screw-on beverage pod having an internal liquid container.

FIG. 8 shows how glue can be applied to fabricate a beverage pod with an internal liquid container.

FIG. 9 shows various embodiments of at least one beverage pod having an internal liquid container inside a freshness bag.

FIG. 10 shows a freshness bag that holds multiple beverage pods.

FIG. 11 shows one embodiment of the multiple compartment beverage pod of present invention.

FIG. 12 shows an embodiment of the multiple compartment beverage pod with an outer shell that has openings in its sides.

FIG. 13 shows an embodiment of a beverage (e.g., coffee or tea) brewing machine that accepts a beverage pod which has multiple compartments.

### DETAILED DESCRIPTION

The present invention relates to a single serve beverage pod, capsule, cartridge, or container (hereinafter referred to collectively as a “pod”) that has multiple, separate compartments for containing different ingredients for making the beverage. The self-contained, imperforate beverage pod contains multiple beverage ingredients, which can be either solid or liquid in form, stored in separate compartments. The ingredients are physically separated and kept apart by the multiple, separate compartments or chambers within the beverage pod. The beverage pod is designed to be pierced one or more times to allow liquid (e.g., hot water) to be injected into one or more of the compartments and for ingredients and/or brewed drinks to flow out of the beverage pod and brewing machine into an awaiting cup.

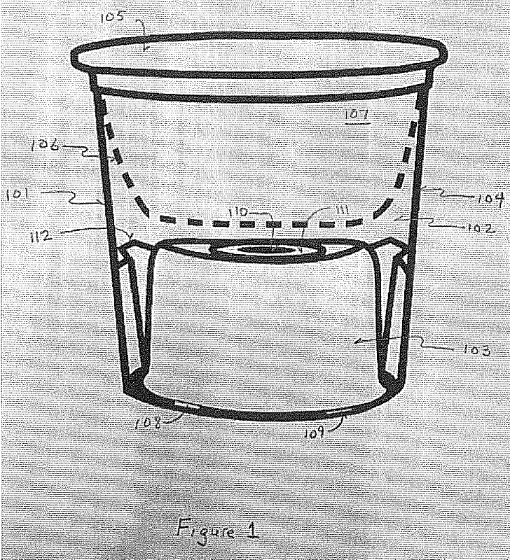

FIG. 1 shows a beverage pod 101. In one embodiment, beverage pod 101 has dimensions that fit into a standard Keurig brewing machine. The dimensions are approximately the same as a Keurig K-cup. The beverage pod has at least two compartments 102 and 103. Compartment 102 includes a cylindrical outer shell 104. This outer shell can be made from a food grade safe, plastic #5. A lid 105 is used to seal the top of the first compartment 102. It can be a heat glued aluminum foil. A coffee or tea filter 106 is used to filter the ground coffee or tea residing in the filter sack 107. The first compartment also includes one or more holes or openings at its bottom that allows the brewed beverage to flow out of the first compartment 102 and beverage pod 101. In one embodiment, the bottom of the first compartment 102 is a circular ring shape with intermittent openings 108 and 109 in the ring.

When the beverage pod 101 is inserted into the pod receptacle of a beverage brewing machine, and the lid of the brewing machine is closed down onto the beverage pod, a hollow needle of the beverage brewing machine is forced downwards and punctures the top lid 105. When the brewing process begins, hot water is injected into the filter sack 107. The coffee (or tea) is brewed by the hot water passing through. The brewed coffee drink then flows downward and through the openings (e.g., drain vents) 108 and 109, out from beverage pod 101 and also out from the coffee brewing machine into an awaiting cup underneath.

A separate, second compartment 103 is used to hold a liquid (e.g., liquor, alcoholic drink, liqueur, dairy, syrup, flavoring, etc.). In one embodiment, the second compartment 103 is a cylindrical container made of food grade safe plastic #5. The container fits inside the beverage pod 101. It has a fill hole 110 on top, through which the second compartment is filled with the liquid. In one embodiment, the fill hole 110 is sealed with a negative pressure release valve 111. The negative pressure release valve 111 lets air flow in to the second compartment 103 while preventing the liquid from flowing out through the valve. The function of the negative pressure release valve 111 is to offset the negative pressure. When the second compartment is punctured, the air flowing in from the negative pressure release valve 111 helps the liquid contained therein to flow out from the second compartment 103. In one embodiment, the negative pressure release valve 111 is comprised of an expanded polytetrafluoroethylene (PFTE) membrane. In other embodiments, the fill hole and valve of the liquid container or chamber could be on top, side or bottom.

In one embodiment, the beverage pod 101 is inserted into a receptacle of a beverage brewing machine. When the lid of the beverage brewing machine is manually pressed downward to close the receptacle, the beverage pod 101 is pressed down onto a hollow bottom needle fixed in place at the bottom of the receptacle. This downward pressure and movement cause the hollow bottom needle to puncture the liquid container of the second compartment 103. Once punctured, the liquid contained therein flows out from the compartment through the bottom hollow needle. The liquid flows out from the bottom hollow needle and the beverage brewing machine to a cup placed under the bottom needle. It should be noted that the bottom hollow needle can be offset from the center point of the container. Even with an offset, the rotational orientation by which the beverage pod is inserted can nevertheless cause the bottom hollow needle to puncture the second compartment 103.

In one embodiment, the first compartment 102 and second compartment 103 are fabricated as a single integrated unit.

In one embodiment, the first compartment 102 can be fabricated as a separate unit and inserted into the beverage pod 101. It can be held in place by a holder mechanism 112. Holder mechanism 112 can be a lock, snap, or friction fit mechanism. It can be formed as a single piece with the entire outer cylindrical wall of the beverage pod. It can be snapped together, glued together, and/or screwed together. It can also be secured through the use of alternative locking methods, such as interlocking, latching, taped, heat welding or friction fitted. It receives and holds the container corresponding to the first compartment 102 in place within the beverage pod. The container corresponding to the first compartment can be inserted from the top or bottom of the beverage pod. It can form part of or the entire outer cylindrical wall of the beverage pod 101.

In one embodiment, the second compartment 103 can be fabricated as a separate unit and inserted into the beverage pod 101. It can be held in place by a holder mechanism 112. Holder mechanism 112 can be a lock, snap, or friction fit mechanism. It receives and holds the container corresponding to the second compartment 103 in place within the beverage pod. The container corresponding to the second compartment can be inserted from the top or bottom of the beverage pod 101. It can form part of or the entire outer cylindrical wall of the beverage pod 101.

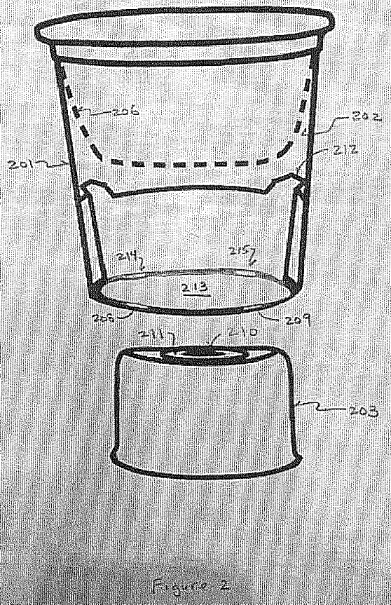

FIG. 2 shows an embodiment of a bottom loading liquid containing container. In this embodiment, the liquid containing container 203 is made from a solid, non-porous material (e.g., food safe plastic #5) and forms the second compartment. It is a hollow cylinder with a fill hole 210 at the top, through which liquid (e.g., alcoholic drink, liquor, dairy product, flavorings, sweeteners, syrups, etc.) can be inserted. It should be noted that a solid ingredient can also be held by this container 203. A negative pressure vent 211 can optionally be used to cover the fill hole 201. In one embodiment, a seal, lid, or some other type of waterproof membrane can be used to seal the fill hole 210. The liquid containing container 203 is inserted upwards through a bottom opening 213 of the beverage pod 201. It is held in place by a holding mechanism 212. It should be noted that container 203 has a solid bottom, but its solid bottom does not cover up one or more drain vents 208, 209, 214, and 215. In one embodiment, there is a single bottom drain vent opening in the middle of the beverage pod, through which the brewed coffee flows out from. The bottom drain vent can have many different sizes, configurations, and shapes, so long as it allows the brewed coffee to drain out of the beverage pod.

A hollow top needle injects hot water into the first compartment 202. The coffee held in filter sack 207 is brewed by the hot water and the brewed coffee flows out from coffee filter 206. It then flows out of the beverage pod 201 through one or more of the drain vents 208, 209, 214, and 215. A hollow bottom needle punctures the bottom of the liquid container 203. The liquid (e.g., alcoholic drink or liquor) flows out from the container 203 and beverage pod 201 through this hollow bottom needle.

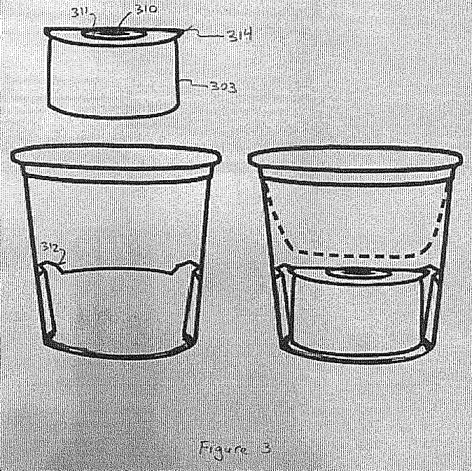

FIG. 3 shows an embodiment of a top loading liquid containing container. In this embodiment, the liquid containing container 303 is made from a solid, non-porous material (e.g., food safe plastic #5) and forms the second compartment. It is a hollow cylinder with a fill hole 310 at the top, through which liquid (e.g., alcoholic drink, liquor, dairy product, flavorings, sweeteners, syrups, etc.) can be inserted. It should be noted that a solid ingredient can also be held by this container 303. A negative pressure vent 311 can optionally be used to cover the fill hole 310. In one embodiment, a seal, lid, or some other type of waterproof membrane can be used to seal the fill hole 310. The liquid containing container 303 is inserted downwards through an open top of the beverage pod 301. In one embodiment, the outer lip 314 of the liquid container 303 extends beyond the cylindrical wall. The holding mechanism 312 holds the liquid container 303 by friction pressure on the outer lip 314.

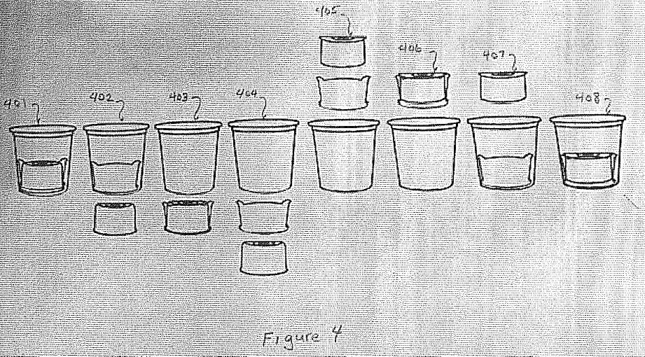

FIG. 4 shows various embodiments of the invention having one, two, or three pieces with corresponding top and bottom loading options. Beverage pod 401 shows a single piece K-cup fabrication configuration. The internal liquid container, holder and ground coffee container are all formed from a single piece. In one embodiment, this configuration may not have a separate holder. Instead, the internal liquid container is formed as part of the overall integrated piece or is glued in place. Beverage pod 402 shows a two-piece K-cup fabrication configuration. In this embodiment, the ground coffee container and holder forms one piece, and the internal liquid container forms a second piece. The internal liquid container is inserted from the bottom upwards into the beverage pod and held in place by the holder. Beverage pod 403 shows a two-piece K-cup fabrication configuration. In this embodiment, the ground coffee container forms one piece, and the holder and internal liquid container forms a second piece. The holder and internal liquid container piece is inserted upwards from the bottom into the beverage pod. Beverage pod 404 shows a three-piece K-cup fabrication configuration. The ground coffee container forms a first piece; the holder is a second piece; and the internal liquid container forms a third piece. In this embodiment, the internal liquid container is inserted upwards from the bottom into the holder. The holder is inserted upwards from the bottom into the ground coffee container. The holder can be inserted first or the internal liquid container can be inserted first.

Beverage pod 405 shows a three-piece configuration that is top loaded. The separate first piece internal liquid container is inserted downwards from the top into the separate second piece holder. The holder is inserted downwards from the top into the separate piece ground coffee container. The internal liquid container can be inserted first or the holder can be inserted first. Both sequences work. Beverage pod 406 shows a two-piece top loading configuration. In this embodiment, the internal liquid container and holder forms a first piece. The first piece is loaded downwards from the top into the ground coffee container. Beverage pod 406 shows a different way to implement a two-piece top loading configuration. The internal liquid container forms a first piece. It is inserted downwards from the top into the second piece which includes the holder and the ground coffee container. Beverage pod 407 shows an integrated single piece K-cup configuration whereby the internal liquid container has an extended lip that is used to keep the container fixed in place within the beverage pod.

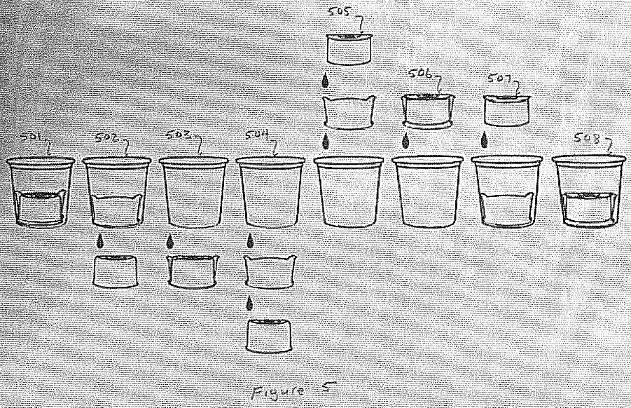

FIG. 5 shows various embodiments for fabricating the beverage pod with the use of glue. The glue can be standard liquid or solid drying glue or it can be heat glued. Beverage pod 501 shows an embodiment which has a single integrated configuration in which all parts are formed from a single part (e.g., plastic molding). Beverage pod 502 shows an embodiment of a two-piece bottom loading internal liquid chamber that is glued into the ground coffee container. A holder can optionally be used to help with the insertion and attachment of the glued internal liquid container.

Beverage pod 503 shows an embodiment of a two-piece bottom loading internal liquid chamber and holder that is glued in place inside the beverage pod. Beverage pod 504 shows an embodiment of a bottom loading K-cup configuration that has the internal liquid container glued with the holder, and the holder glued in the beverage pod.

Beverage pod 505 shows an embodiment of a three-piece top loading K-cup configuration that has the internal liquid container glued in the holder, and the holder is glued in the beverage pod. Beverage pod 506 shows an embodiment of a two-piece top loading K-cup configuration that has the internal liquid container and holder glued in the beverage pod. The holder is optional one corresponding embodiment. FIG. 507 shows a two-piece top loading K-cup configuration that has an internal liquid container glued into the beverage pod and holder. In one corresponding embodiment, the holder is optional. Beverage pod 508 shows an embodiment with no glue. The internal liquid container has an extended lip or other part which helps keep it fixedly held in place within the beverage pod.

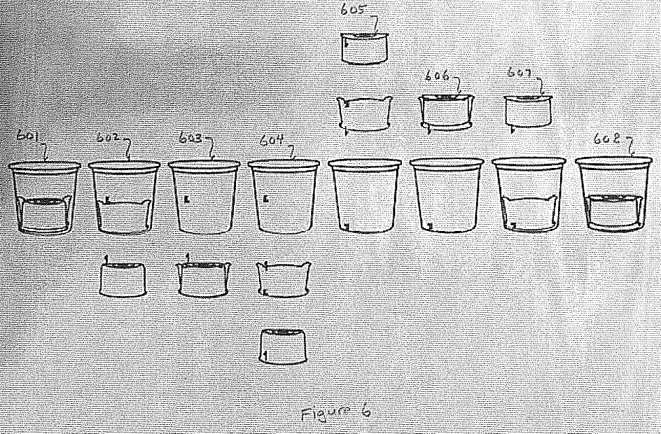

FIG. 6 shows various embodiments of a multi-compartment snap-on beverage pod configuration. Beverage pod 601 shows an embodiment of a multi-compartment beverage that is comprised of a single piece. The internal liquid container, holder, and ground coffee container are formed from a single piece of material (e.g., plastic). The holder is optional. Beverage pod 602 shows a two-piece snap-on bottom loading beverage pod configuration. In this embodiment, the internal liquid container is inserted upwards from the bottom and snapped and locked in place with the use of a snap locking mechanism. A holder can optionally be used to help with the snap-on process. Beverage pod 603 shows another embodiment of a two-piece snap-on bottom loading beverage pod configuration. The internal liquid container and holder forms a first piece. It is inserted upwards from the bottom of the beverage pod. The ground coffee is contained in the second container. A snap-on mechanism fixedly holds the first piece in place. Beverage pod 604 shows a three-piece bottom loading beverage pod configuration. The internal liquid container is snapped upwards into the holder from the bottom. The holder is snapped upwards into the beverage pod from the bottom.

Beverage pod 605 shows a three-piece top loading beverage pod configuration. The liquid inner container is snapped downwards and locked into the holder from the top. The holder is snapped downwards and locked into place in the beverage pod with the use of a snap-on mechanism. Beverage pod 606 shows a two-piece top loading beverage pod configuration. The internal liquid container and holder forms a first piece that is snapped downwards from the top and locked into the second piece beverage pod body by means of a snap-on locking mechanism. Beverage pod 607 shows an alternative embodiment of a two-piece top loading beverage pod configuration. The internal liquid container forms a first piece which is snapped downwards from the top and locked into place in a beverage pod with a holder by means of a snap-on locking mechanism. Beverage pod 608 shows an integrated beverage pod with an extended lip or other portion that helps hold the internal liquid container in place.

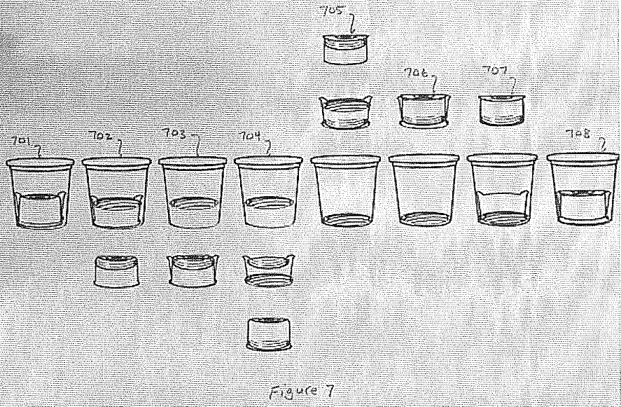

FIG. 7 shows various embodiments of a screw-on beverage pod having an internal liquid container. Beverage pod 701 shows an embodiment which has a single integrated configuration in which all parts are formed from a single part (e.g., plastic molding). Beverage pod 702 shows an embodiment of a two-piece bottom loading internal liquid chamber that is screwed into the ground coffee container. A holder can optionally be used to help with the insertion and attachment of the glued internal liquid container. Beverage pod 703 shows an embodiment of a two-piece bottom loading internal liquid chamber and holder that is screwed in place inside the beverage pod. Beverage pod 704 shows an embodiment of a bottom loading K-cup configuration that has the internal liquid container screwed in the holder, and the holder is screwed in the beverage pod.

Beverage pod 705 shows an embodiment of a three-piece top loading K-cup configuration that has the internal liquid container screwed in the holder, and the holder is glued in the beverage pod. Beverage pod 706 shows an embodiment of a two-piece top loading K-cup configuration that has the internal liquid container and holder screwed in the beverage pod. The holder is optional one corresponding embodiment. FIG. 707 shows a two-piece top loading K-cup configuration that has an internal liquid container screwed into the beverage pod and holder. In one corresponding embodiment, the holder is optional. Beverage pod 708 shows an embodiment with the internal liquid container having an extended lip or other part which helps keep it fixedly held in place within the beverage pod.

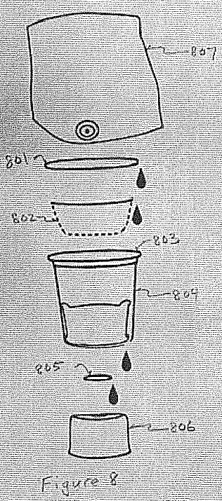

FIG. 8 shows how glue can be applied to fabricate a beverage pod with an internal liquid container. The glue can be dry, liquid, or heat activated. The glue can be applied across an entire surface or limited to the contact portions that need to be stuck together. One or more of the following contact regions can be glued together. The upper lid 801 can be glued to the coffee filter 802. The coffee filter 802 can be glued to the upper lip 803 of the beverage pod 804. The negative pressure release valve 805 can be glued onto the internal liquid container 806. The liquid container 806 can be glued inside the beverage pod body 804. Optionally, the beverage pod can be kept inside a freshness bag 807 that has a freshness valve 808. The freshness valve 808 vents gas emanating from the ground coffee or coffee beans out of the bag and keeps air from flowing into the bag.

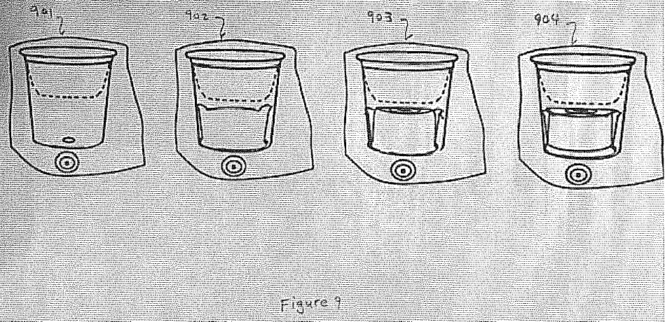

FIG. 9 shows various embodiments of at least one beverage pod having an internal liquid container inside a freshness bag. The freshness bag has a freshness valve. The freshness valve lets gas emanating from the coffee out of the bag but keeps outside air from entering the bag. Freshness bag 901 contains at least one beverage pod having coffee and a filter with an opening at the bottom to let brewed coffee flow out. Freshness bag 902 contains at least one beverage pod having a holder. Freshness bag 903 contains at least one beverage pod having a holder and an internal liquid container. Freshness bag 904 contains at least one beverage pod having a holder and an internal liquid container having an extended lip that helps keep the container in place.

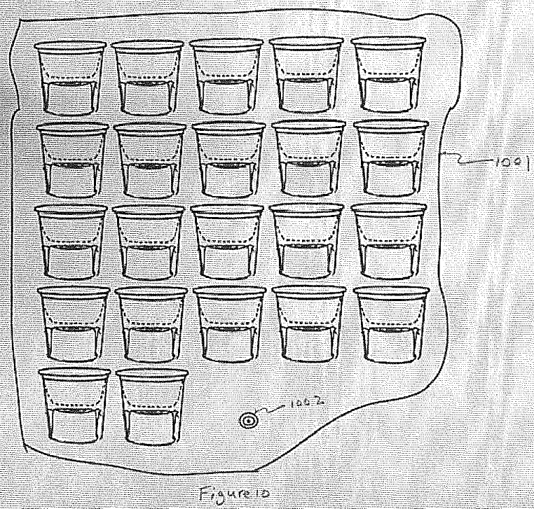

FIG. 10 shows a freshness bag that holds multiple beverage pods. The beverage pods can be standard K-cup, Nespresso, Tassimo, disc, capsule, or any other single serve beverage pod configuration. In the currently preferred embodiment, the freshness bag 1001 contains multiple beverage pods that have internal liquid containers. These beverage pods can contain different types of drinks and/or drink recipes. A single or multiple freshness vent 1002 is used to let the gas emitted from the coffee inside the beverage pods to flow out from the freshness bag while keeping outside air from flowing into the freshness bag.

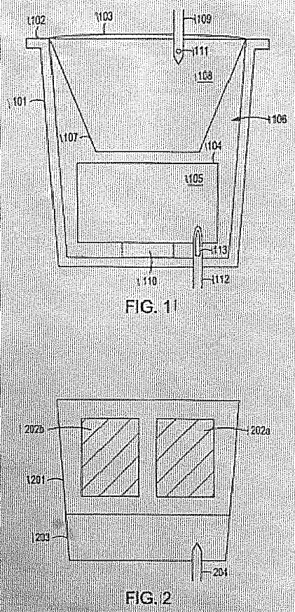

FIG. 11 shows one embodiment of the multiple compartment beverage pod of present invention. A perspective view of a beverage pod 1101 is shown. The beverage pod 1101 is comprised of a non-permeable (to water and air) outer shell 1102 and a top cover 1103, which seals the contents housed within the beverage pod 1101. Residing within the outer shell 1102 and top cover 1103 is a solid, self-contained, non-porous, imperforated inner housing 1104. Inner housing 1104 can be plastic or some other rigid material that can be water tight and/or air tight. The contents contained within inner housing 1104 will not leak out or evaporate out of the compartment. Inner housing 1104 is set firmly on top of an offset base 1110, such that it is raised above the floor of the plastic outer shell 1102. This creates a circular gap between the floor of the plastic outer shell 1102 and the bottom of the inner housing 1104. It should be noted that in other embodiments, there is no gap between the inner housing 1104 and the bottom or side of the outer shell 1102. In other words, the bottom or side(s) of the outer shell can form part of the inner compartment. The inside of inner housing 1104 forms a first compartment 1105. This first compartment 1105 can be filled with a liquid or solid beverage ingredient. For example, the first compartment 1105 of inner housing 1104 can be filled with alcohol, liquor, cocktail, mixed drink, garnishes, cocoa, flavorings, sweeteners, honey, cream, seasoning, etc. or a combination thereof. The volume of area outside of inner housing 1104 but inside of the plastic outer shell 1102 and top cover 1103 forms a second compartment 1106. A permeable filter 1107 defines a third compartment 1108, which can hold dry ingredients such as ground coffee, espresso coffee, tea leaves, powdered drink, etc.

In this embodiment, the beverage pod 1101 is pierced by one or more needles. More particularly, when used in a brewing machine, the beverage pod 1101 is pierced at its top, puncturing and passing through top cover 103, using a hollow needle 1109. During brewing, the needle 1109 injects liquid (e.g., hot or cold water) into the beverage pod 1101 through an opening 1111 in the needle 1109. The liquid passes through and mixes with the ingredient 1108 held by the permeable filter 1107. The mixture then flows through compartment 1106 and exits through another hollow needle 1112. Hollow needle 1112 pierces through the bottom of the plastic outer shell 1102 and also through container 1104. Hollow needle 1112 has an opening 1113 that extends through both compartment 1105 and compartment 1106. Thereby, the ingredients in compartments 1105 and 1106 flow or pass through the hollow needle 1112 and exits one or more exit ports in a brewing chamber of the brewing machine (the brewing chamber is the portion of the brewing machine that receives the beverage pod 1101) and drips into a pot, cup, or other receiving receptacle. This needle may be referred to as a nozzle.

An example of how this novel beverage pod 1101 works is now described in detail. Ground coffee or espresso coffee is held in a filter 1107. An alcoholic liquid, such as Irish Cream, whiskey, rum, peppermint schnapps, Kahlua, vodka, martini or any combination of liquors is contained in container 1104. The user inserts this pre-packaged beverage pod 101 into the receptacle of a brewing machine designed specifically for receiving such beverage pods. Once the receptacle is closed, the top needle 1109 pierces the top cover 1103 and the bottom needle pierces the bottom of the outer shell 1102 as well as the container 1105. The user simply hits a button selecting the serving size. Water from the water receptacle filled by the user is immediately heated to the proper temperature to brew the coffee. Once heated, the water flows through the top needle 1109 into the ground coffee within filter 1107. The filter keeps the ground coffee from leaving the beverage pod. The brewed coffee flows through the filter 1107 into compartment 1106 and out from the beverage pod 101 through the hollow bottom needle 1112 into an awaiting coffee cup. In addition, the alcohol within 1105 also flows through the hollow bottom needle 1112. One design allows for both the brewed coffee and the alcohol to flow through the bottom hollow needle 1112 at the same time, to mix together.

In one embodiment, the top cover 1103 and the shell 1102 body may form an air-tight enclosure. In other words, the beverage pod 1101 may be air-tight. In addition, the interior of the beverage pod 1101 may be nitrogen flushed when the top cover 1103 is applied to expel oxygen from the enclosure to prevent the degradation of the ingredients. In one example, the body portion of the beverage pod 1101 has a truncated conical shape (e.g., shaped like a bucket or pail) or cylindrical in shape. The body portion of beverage pod 1101 may include a ring portion which contacts the receptacle seating of the brewing machine that holds the beverage pod 1101 in place. In other embodiments, there can be multiple top needles and/or multiple bottom needles. There can also be other paths and openings created, by which hot water can enter compartment 1108.

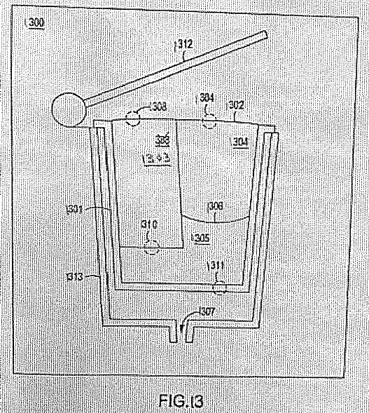

FIG. 12 shows an embodiment of a multiple compartment beverage pod with an outer shell 1202 that has openings in its sides. The openings are covered by filters or meshes (e.g., filter 1202a and 1202b). The inside of the outer shell 1202 forms a first compartment that can contain dry ingredients, such as coffee, espresso, tea, etc. A second shell 1203 can be fabricated by a solid non-permeable material. Inside of second shell 1203 is a second compartment, which can contain a dry or liquid ingredient (e.g., alcohol, dairy product, flavorings, spices, sugar, honey, etc.). Hot water can enter the compartment formed by the outer shell 1202 through the top via a hollow needle, mesh, or opening in the top. The hot water can also enter the first compartment through the filter openings 1202a and 1202b. The mixture of the water and ingredients of the first compartment (e.g., brewed coffee) can flow out from the openings and filters 1202a and 1202b. Outer shell 1203 can be pierced by a hollow needle 1204 or an opening can be created by other means to release the contents or ingredients in the second compartment. The mixture of the water, ingredients from the first compartment, and the ingredients from the second compartment all flow into a cup, mug or other drinking container.

In one embodiment, because the pod is defined by a permeable filter, which acts as a housing for the pod, there is no need to puncture the bottom of the pod in order to extract the brewed liquid.

FIG. 13 shows an embodiment of a beverage (e.g., coffee or tea) brewing machine 300 that accepts a beverage pod 1301 that has multiple compartments. Beverage pod 1301 is a disposable, single-serve or reusable pod for brewing a beverage. It is inserted or laid in place onto a receptacle 1313 in the brewing machine. Receptacle 1313 is specially designed to accept and fit the beverage pod 301. A lid 1312 can be used to open and close beverage pod receptacle 1313. Closing lid 1312 can activate the brewing process.

Beverage pod 1301 is sealed with a top cover 1302. Beverage pod 1301 has multiple compartments that can contain dry and/or liquid contents therein. One or more of these compartments can be sealed off, isolated, self-contained, water-tight, and/or air-tight. For example, compartment 1303 is defined by a solid, non-permeable, imperforated, water-tight plastic container. Consequently, it can contain a liquid (e.g., alcoholic liquor, dairy product, flavor extracts, etc.). In this embodiment, compartment 1303 has a vertical orientation. It is more tall than wide. In other embodiments, compartment 1303 is horizontal in orientation (e.g., more wide than tall) or a combination horizontal and vertical thereof. A separate compartment 1304 can contain a dry ingredient, such as ground coffee, tea leaves, drink powders, etc. A filter, mesh, screen, or membrane 1306 can be incorporated to retain the contents of compartment 1304. An optional third compartment 305 can contain another type of dry or liquid ingredient (e.g., spices, thickening agent, flavor enhancers, coloring agents, aromatics, etc.). One or more openings can be created in the top, bottom, or sides of these compartments to release their respective contents. For example, compartment 1303 can have one or more openings 1308 created to vent its contents. Opening(s) 308 can also be created to inject a gas or liquid int compartment 1303. One or more openings 1310 can be created to release the contents of compartment 1303. Similarly, one or more openings 1309 can be created to vent or introduce liquids or gases into compartment 1304. For example, hot water at the ideal brewing temperature can be pressurized and injected into compartment 1304 to brew the coffee contained in compartment 1304. Similarly, one or more openings 311 can be created to release the contents of the third compartment 1305. For example, the brewed coffee from compartment 1304 can flow and mix with cocoa, peppermint, nutmeg, cinnamon, sugar, diary powder, etc. held by compartment 1305. One or more openings 1311 in beverage pod 1301 can be created to allow the contents of the various compartments 1303-1305, along with the hot/cold water inserted into the beverage pod to be released and flow into the receptacle 1313 holding the beverage pod 1301. These openings can be created by needles (hollow or solid), pull-outs, punch-outs, pins, lids, membranes (permeable, dissolvable, elastic), etc. One or more exit ports 1307 enables the contents to flow out of the brewing machine 1300 into an awaiting cup or beverage holder for the user to drink.

In one embodiment, one or more vents can be implemented to facilitate the release of the liquid contents (e.g., liquor or alcoholic drink). The vent is located at the top of the liquid containing compartment. It is normally closed to ensure integrity of liquid compartment. However, during the brewing process, the vent is opened to help relieve the negative pressure in the liquid compartment so that the liquid contents can flow out easily. It should be noted that one of the sides of the liquid compartment can arise up to the top of beverage pod, which means that the vent is at the top (e.g., top cover) of beverage pod. Likewise, the vent located on the side of compartment and/or side of beverage pod is normally kept closed to maintain the integrity of contents of the liquid compartment. It remains closed until the brewing process causes it to open, which relieves the negative pressure in the liquid compartment. Once the negative pressure is relieved, the liquid contents can flow out from the bottom hollow needle. In one embodiment, a vent can be made large enough to overcome whatever negative pressure is experienced by the liquid compartment. The vent is normally kept closed until the hollow needle forces it open. The opening of the vent is large enough so that the liquid contents of the liquid compartment can readily flow out of the beverage pod through the vent in part or in total. In one embodiment, the vent is a circular strip or disc, so that no matter how the beverage pod is rotationally inserted into the beverage brewing machine, the lower needle will prop it open. The lower needle pokes and lifts up an edge of the circular strip/disk/plate of the vent.

Various embodiments exist for implementing a vent. In one embodiment, a vent is comprised of a hinged tab. The hinged tab can be rectangular with three weak, thinner edges and one hinge edge such that the force of the water pressure or a needle causes the three sides of the rectangular tab to pop open and release the brewed beverage from the compartment. The hinge keeps the rectangular tab from dislodging and falling out of the beverage pod. The hinged tab can also be U shaped.

In one embodiment, a vent can be comprised of a pull tab. The pull tab is normally sealed or taped shut by a light glue. The user or brewing machine actively pulls the tab away from the compartment to help release its contents and/or counteract the negative pressure inside the compartment.

In one embodiment, a vent can be comprised of a hinged tear-off flap. The flap is normally in a closed, sealed position before the pod is inserted into the beverage machine. The flap opens along the cut-out perimeter when a force is applied (e.g. water pressure, force by needle, etc.) immediately before or during the brewing process. The hinged portion of the flap ensures that the flap does not separate and dislodge from the beverage pod. The hinged vent can alternatively have a cut-away portion, a punch out portion, a pull away, push out, strike out, ejection, or any other way of dislodging, separating, or unsealing the flap from the container or compartment. The releasable portion can be made of plastic, wherein one or more edges are made weaker, thinner, semi perforated, such that a slight force can cause the edge(s) to separate from the rest of the outer container.

In one embodiment, a vent can be comprised of a one-way valve. This valve can let air into the compartment, but keeps liquids from leaking out of the compartment. This prevents negative pressure from occurring inside the compartment.

In another embodiment, a vent can be comprised of an expanded polytetrafluoroethylene (PFTE) membrane (e.g. Gore-Tex™). This membrane is highly durable, breathable, and waterproof. The ePFTE membrane keeps the liquid inside the compartment, but lets air in. Consequently, it effectively prevents negative pressure from occurring inside the compartment. Anytime the compartment is pierced, the liquid inside readily flows out. The ePFTE membrane is heat sealed, glued, or otherwise secured in place to cover a portion or the entire top of the liquid compartment.

In one embodiment, the vent can be a plug or cork. An opening in the compartment is plugged or corked to seal its contents. When a force is applied (e.g., water pressure or force by a needle), the plug or cork pops out of the opening, thereby releasing the liquid contents. The plug or cork can take the shape and function of a man-hole cover. The top part is slightly larger in circumference than the bottom part. The bottom part plugs an opening.

In one embodiment, a compartment can be pressurized with a gas. Thereby, when the compartment is pierced, the pressurized gas expels the liquid contents contained therein.

In another embodiment, the compartment can be made from an elastic material. Filling the compartment with a liquid content, expands the elastic material. Once filled, the elastic compartment is sealed. When the compartment is pierced (e.g., by a needle), the elasticity contracts, thereby expelling its liquid contents from the compartment.

In one embodiment, the compartment is comprised of a pressurized aerosol canister. The canister is filled with a liquid and holds this liquid until the brewing process. Thereupon, a valve is activated to cause the aerosol canister to expel the liquid. Alternatively, a valve may not even be necessary. The aerosol canister need only be pierced to cause its liquid contents to be forcibly expelled.

In one embodiment, the vent is of a size to open at least two compartments within the beverage pod. For example, the vent is large enough to span the container holding the liquid and also the container holding the dry ingredient. When opened during the brewing process, both the brewed beverage and the liquid (e.g., alcoholic drink) can both flow out of the same vent.

In other embodiments, additional compartments can be implemented in the beverage pod. A third, fourth, fifth, etc. compartment can be used to contain and keep separate any number of liquid or dry ingredients or combination thereof. These additional compartments can be porous or non-porous, rigid or flexible, water tight, and/or air tight.

In some embodiments, the single-serve container is a K-Cup™ container. K-cup containers are described in greater detail in U.S. Pat. No. 5,840,189, the contents of which are hereby incorporated by reference herein.

In some embodiments, the single serve container may be a T Disc™ style container which is configured for use with a Tassimo™ brewer. T disc style containers are described in U.S. Pat. No. 7,231,869 which was filed on Jan. 23, 2004 and which is incorporated herein by reference.

In some embodiments, the single serve container may be a Nespresso™ container or Nespresso™ compatible container. In some embodiments, the single serve container may be a Nescafe™ Dolce Gusto™ style container.

The containers may take other forms apart from those listed above but the general mode of action is similar. The single serve pod serves to hold and protect the liquid and/or other ingredients internally, where the hot water is introduced to extract the actives and then ejected through the brewing machine head. The beverage pod can be made entirely from compostable and/or recyclable materials. In other embodiments, the beverage pod can be reused many times. A user can refill the compartment(s) and reuse the same beverage pods many times over to brew multiple cups of beverages. They can fill the compartments with various ingredients of their choice to brew drinks that suit their particular tastes.

Although illustrative embodiments of the invention have been described in detail herein with reference to the accompanying figures, it is to be understood that the invention is not limited to those precise embodiment. They are not intended to be exhaustive or to limit the invention to the precise forms disclosed. As such, many modifications and variations will be apparent.

What is claimed is:

1. A disposable, single serve beverage pod for use in a coffee dispensing machine, the beverage pod dispensing an alcoholic coffee beverage, comprising:
a first compartment for containing ground coffee, a coffee filter, and a lid, wherein the first compartment is adapted to have the lid punctured by a top hollow needle of the coffee dispensing machine through which hot water is inserted into first compartment to brew the ground coffee, the coffee filter keeping the ground coffee inside the first compartment, and brewed coffee flows through a bottom opening;
a second compartment for containing an alcoholic liquid that is kept separate from the ground coffee, wherein the second compartment is adapted to be punctured by a bottom hollow needle of the coffee dispensing machine, the alcoholic liquid flowing out of the beverage pod through the bottom hollow needle;
and wherein the brewed coffee from the first compartment and the alcoholic liquid from the second compartment can be dispensed by the coffee dispensing machine.

2. The beverage pod of claim 1, wherein the second compartment is comprised of a water tight container.

3. The beverage pod of claim 2, wherein the water tight container includes a negative pressure valve that helps the alcoholic liquid to flow out from the second compartment when punctured by the bottom hollow needle.

4. The beverage pod of claim 2, wherein the water tight container includes a fill hole for filling the second compartment with the alcoholic liquid.

5. The beverage pod of claim 4, wherein the second compartment includes a membrane sealing the fill hole that lets air flow in but keeps the alcoholic liquid from flowing out.

6. The beverage pod of claim 5, wherein the apparatus comprises an expanded polytetrafluoroethylene material.

7. The beverage pod of claim 6, wherein the expanded polytetrafluoroethylene material securely seals a top portion of the second plastic shell.

8. The beverage pod of claim 1 further comprising a third compartment for containing an additional beverage ingredient.

9. The beverage pod of claim 1 further comprising a securing mechanism for holding the first plastic shell in place with the second plastic shell.

10. The beverage pod of claim 9, wherein the first plastic shell is inserted down into the second plastic shell and held in place by the securing mechanism.

11. The beverage pod of claim 9, wherein the second plastic shell is inserted upwards from a bottom of the first plastic shell and held in place by the securing mechanism.

12. A beverage pod for use in a beverage brewing apparatus, comprising:
a self-contained first compartment integrated within the beverage pod, wherein the self-contained first compartment can hold a first beverage ingredient;
a self-contained second compartment integrated within the beverage pod, wherein the self-contained second compartment can hold a second beverage ingredient, wherein the first beverage ingredient and the second beverage ingredient are physically kept apart by the first compartment and the second compartment;
wherein the beverage pod is adapted to be placed in a holding receptacle of the beverage brewing apparatus and when hot water flows into the first compartment, a brewed liquid resulting from the first beverage ingredient is dispensed from the first compartment and wherein the second beverage ingredient is dispensed from the second compartment, the brewed liquid and second beverage ingredient both being dispensed from the beverage pod and out of the beverage brewing apparatus for human consumption.

13. The beverage pod of claim 12, wherein the beverage pod comprises outer dimensions compatible with standard Keurig brewing machines.

14. The beverage pod of claim 12, wherein the first compartment and the second compartment both reside inside the beverage pod and are external to each other.

15. The beverage pod of claim 14, wherein the first ingredient comprises ground coffee and the second ingredient comprises an alcoholic drink.

16. The beverage pod of claim 12, wherein the first compartment is comprised of a separate piece that is inserted into the beverage pod from the top and held in place inside the beverage pod.

17. The beverage pod of claim 12 further comprising a vent in a bottom portion of the beverage pod through which brewed coffee can flow out from the beverage pod.

18. The beverage pod of claim 12 further comprising a negative pressure vent that helps liquid to flow out from the second compartment when the second compartment is punctured.

19. The beverage pod of claim 18, wherein the negative pressure vent comprises an expanded polytetrafluoroethylene material.

20. A capsule for use in a beverage brewing machine, comprising:
an outer housing;
a lid for sealing a top of the outer housing;
a section within the outer housing for holding ground coffee;
a container residing inside the plastic outer housing for holding a liquid beverage, wherein the liquid beverage is kept separate from the ground coffee.

21. The capsule of claim 20 further comprising an opening in a bottom portion of the outer housing through which brewed coffee can exit from the capsule and wherein the capsule is adapted to be punctured by the beverage brewing machine from a top hollow needle to insert hot water to brew the coffee and a bottom hollow needle that punctures the container to release the liquid beverage from the capsule.

22. The capsule of claim 20, wherein the container comprises a plastic housing that holds an alcoholic liquid.

23. The capsule of claim 20, wherein the container is inserted into the capsule and held in place though a securing mechanism.

24. The capsule of claim 20 further comprising a mechanism that lets air flow into the container but prevents liquid from exiting the container.

25. The capsule of claim 24, wherein the outer housing has dimensions that are same as standard Keurig K-cups.

26. A single beverage pod for use in a beverage brewing machine that dispenses an alcoholic coffee drink, comprising:
a first container for holding ground coffee;
a coffee filter for filtering the ground coffee so that it does not exit the beverage pod when the coffee is being brewed;
a second container for holding a liquid alcoholic beverage, wherein the liquid alcoholic beverage is kept separate from the ground coffee;
wherein as part of a brewing process, the liquid alcoholic beverage flows out from the second container and brewed coffee flows out from the first container, the beverage brewing machine dispensing the alcoholic coffee drink into an awaiting cup.

27. The single beverage pod of claim 26 further comprising a bottom vent for allowing the coffee to flow out from the beverage pod.

28. The single beverage pod of claim 26, wherein the beverage pod is held in a bag with a freshness vent.

29. The single beverage pod of claim 26, wherein either of the first container and the second container can be inserted into the beverage pod from either the top or bottom.

30. The single beverage pod of claim 26 further comprising a hole in the second container for filling the second container with the liquid alcoholic beverage and a membrane sealing the hole allows air to flow into the second container but keeps the liquid alcoholic beverage from flowing out of the second container.
